(19) United States
(12) Patent Application Publication
(10) Pub. No.: US 2014/0334086 A1
(43) Pub. Date: Nov. 13, 2014

(54) ELECTRONIC SYSTEM

(71) Applicants: Mei-Fang Chou, Taipei City (TW); San-Feng Lin, Taipei City (TW)

(72) Inventors: Mei-Fang Chou, Taipei City (TW); San-Feng Lin, Taipei City (TW)

(73) Assignee: ASUSTEK COMPUTER INC., Taipei City (TW)

(21) Appl. No.: 14/269,198

(22) Filed: May 4, 2014

Related U.S. Application Data
(60) Provisional application No. 61/820,717, filed on May 8, 2013.

(30) Foreign Application Priority Data
Jan. 16, 2014 (TW) 103101621

(51) Int. Cl. G06F 1/16

(52) U.S. Cl. CPC G06F 1/1679
USPC 361/679.17; 361/679.55

(57) ABSTRACT

An electronic system including a first electronic device, an electronic control locking device and a second electronic device is provided. The first electronic device is suitable for being combined with the second electronic device and the first electronic device includes a system operation center. The electronic control locking device is electrically connected to the first electronic device, and the first electronic device sends a locking command to control the electronic control device to lock the first electronic device to the second electronic device. The first electronic device sends an unlocking command to control the electronic control locking device to unlock to make the first electronic device detached from the second electronic device.

### CROSS-REFERENCE TO RELATED APPLICATION

This application claims the priority benefits of U.S. provisional application Ser. No. 61/820,717, filed on May 8, 2013 and Taiwan application serial no. 103101621, filed on Jan. 16, 2014. The entirety of each of the above-mentioned patent applications is hereby incorporated by reference herein and made a part of this specification.

### BACKGROUND OF THE INVENTION

1. Field of the Invention

The invention relates to an electronic system and, more particularly, to an electronic system including electronic control locking device.

2. Description of the Related Art

FIG. 1 is a schematic diagram showing a conventional electronic system. Please refer to FIG. 1, a conventional electronic system 100 such as a notebook has a first unit 110 and a second unit 120, a system operation center and a storage device are disposed at the second unit 120, and the first unit 110 includes a display module: The second unit 120 connects to the first unit 110 via a pivot unit 130 and rotates relatively to each other and cannot be separated.

Since tablet computers have small, light, thin, and portable advantages, they become popular quickly. However, the tablet computers equip virtual keyboards, which is rather inconvenient. Therefore, some tablet computers can be cooperated with an external keyboard module. However, the external connected keyboard module decreases portable potency.

### BRIEF SUMMARY OF THE INVENTION

An electronic system including an electronic control locking device is provided.

An electronic system including a first electronic device, an electronic control locking device, a second electronic device is provided. The first electronic device includes a system operation center, and the second electronic device includes a storage device. When the first electronic device is combined with the second electronic device, the first electronic device sends a locking command to control the electronic control locking device to lock the first electronic device to the second electronic device; when the first electronic device sends an unlocking command, the electronic control locking device is controlled to unlock in order to make the first electronic device detached from the second electronic device.

As described above, an electronic system including an electronic control locking device is provided. When the first electronic device is combined with the second electronic device, the first electronic device and the second electronic device are locked together via the electronic control locking device, thus to prevent the first electronic device from being detached from the second electronic device when the electronic system is in use.

In order to facilitate understanding, the invention is illustrated with embodiments and accompanying figures.

### BRIEF DESCRIPTION OF THE DRAWINGS

FIG. 1 is a schematic diagram showing a conventional electronic system;

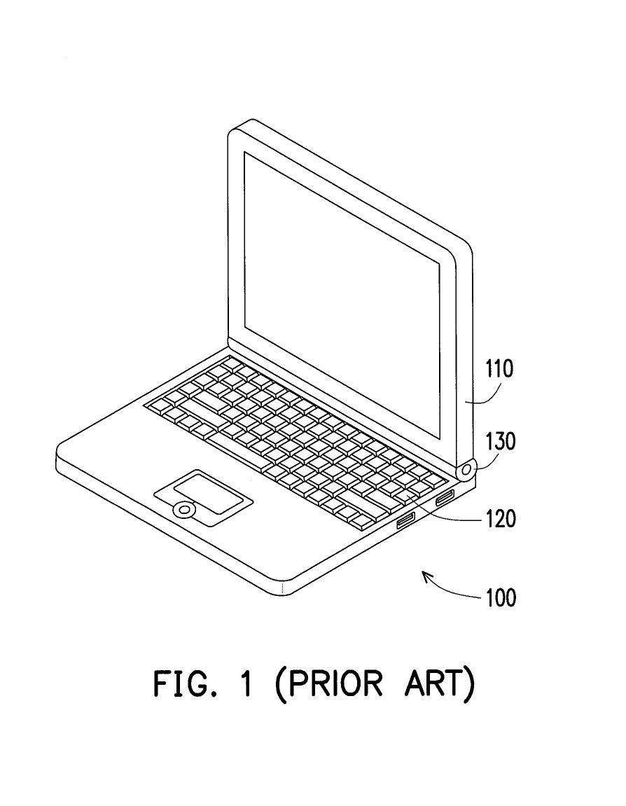

FIG. 2 is a schematic diagram showing an electronic system in an embodiment; and

FIG. 3 is a block diagram showing an electronic system shown in FIG. 2 in an embodiment.

### DETAILED DESCRIPTION OF THE EMBODIMENTS

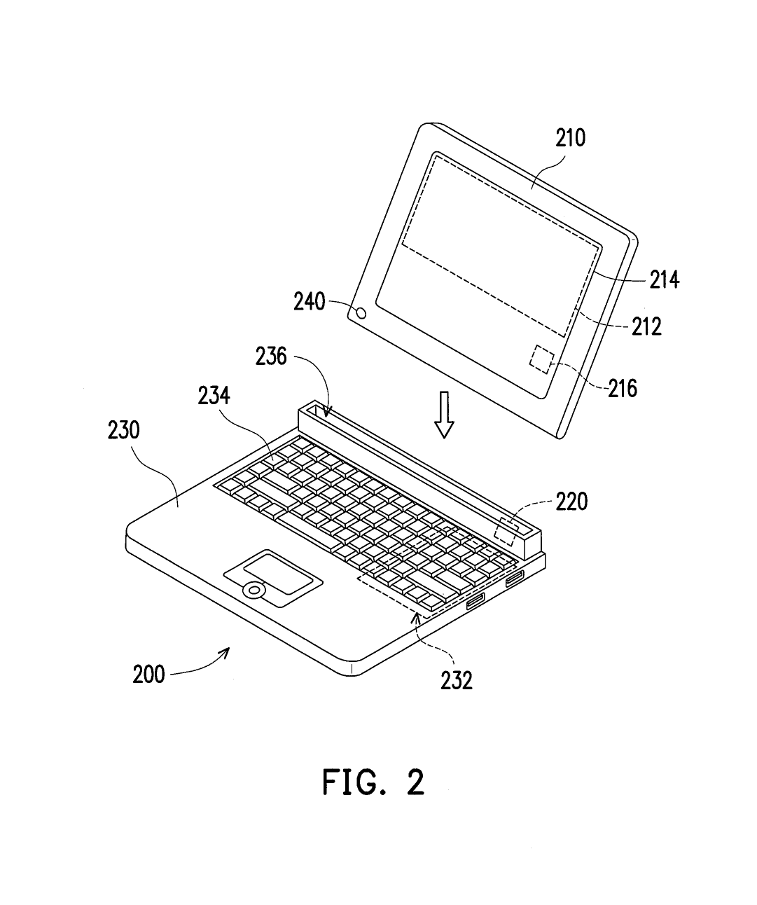

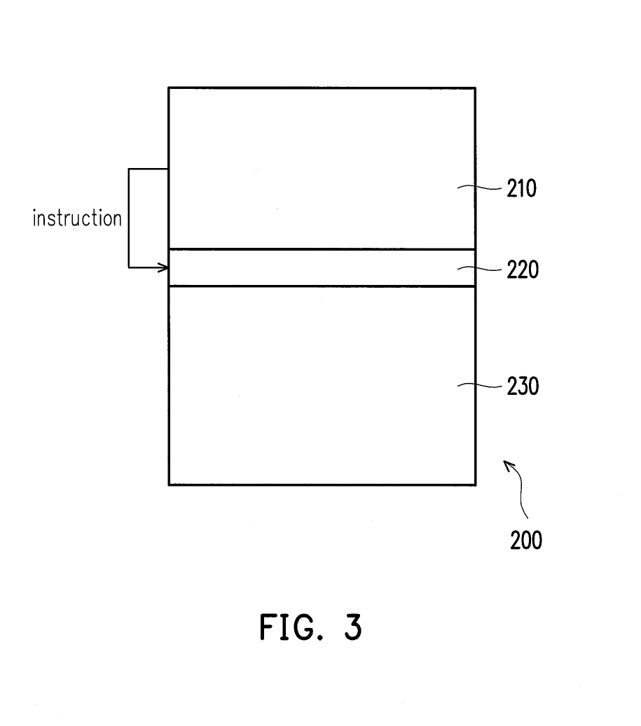

FIG. 2 is a schematic diagram showing an electronic system in an embodiment. FIG. 3 is a block diagram showing an electronic system shown in FIG. 2 in an embodiment. Please refer to FIG. 2 and FIG. 3, an electronic system 200 includes a first electronic device 210, an electronic control locking device 220 and a second electronic device 230. The first electronic device 210 includes a system operation center 212. The electronic control locking device 220 is electrically connected to the first electronic device 210. When the first electronic device 210 is combined with the second electronic device 230, the first electronic device 210 controls the electronic control locking device 220 to lock the first electronic device 210 to the second electronic device 230, therefore the first electronic device 210 and the second electronic device 230 are not detached easily.

In detail, the first electronic device 210 includes a display screen 214 electrically connected to the system operation center 212. The display screen 214 displays an operation processing result of the system operation center 212. The second electronic device 230 itself may be a storage device, or it may include a storage device 232 (in this embodiment, the second electronic device 230 includes a storage device 232 as an example). When the first electronic device 210 is attached to the second electronic device 230, the first electronic device 210 is electrically connected to the second electronic device 230. The first electronic device 210 may further include a first storage device 216 which stores small capacity or the operation processing result of the system operation center 212 temporarily. The capacity of the storage device 232 of the second electronic device 230 is larger than that of the first storage device 216 of the first electronic device 210.

The first electronic device such as a tablet computer includes a system operation center 212, a display screen 214 and a first storage device 216, and a first operating system(such as an operating system) is installed inside the tablet computer. The second electronic device 230 may include a keyboard module 234 and a storage device 232. When the first electronic device 210 is combined with the second electronic device 230, the keyboard module 234 and the storage device 232 are electrically connected to the first electronic device 210, respectively. A second operating system (such as a window operating system) may be installed in the storage device 232 of the second electronic device 230.

The second electronic device 230 includes a slot 236 for inserting the first electronic device 210 thereto. The electronic control locking device 220 may be disposed in the slot 236 of the second electronic device 230 or disposed in the first electronic device 210, which is not limited herein and can be chosen according to requirements. The electronic control locking device 220 receives a command from the first electronic device 210, and the first electronic device 210 and the second electronic device 230 are locked each other. The electronic control locking device 220 may be an electromagnet or a motor, which is not limited herein. In other words, the first electronic device 210 and the second electronic device 230 can be locked each other by controlling the electronic control locking device 220.

When the first electronic device 210 combines to the second electronic device 230, the first electronic device 210 communicates with the second electronic device 230. However, some problems, such as a data transfer error results the damage of the first electronic device 210 or the second electronic device 230 might be caused while the communication is executing. For example, when a command is inputted at the keyboard module 234 of the second electronic device 230 to transfer data stored in the first storage device 216 of the first electronic device 210 to the storage device 232 of the second electronic device 230, the data transferring error might occur if the first electronic device 210 is mistakenly detached from the second electronic device 230. In order to prevent the problems, the first electronic device 210 sends a locking command to control the electronic control locking device 220 to make the first electronic device 210 and the second electronic device 230 locked each other. The locking command may be an instruction from a user, or generated according to a sensing result of a sensor 240 positioned at the first electronic device 210 or the second electronic device 230, or when a first operating system of the first electronic device 210 is switched to a second operating system (such as a window operating system).

When the first electronic device 210 sends an unlocking command, the first electronic device 210 controls the electronic control locking device 220 to unlock in order to detach the first electronic device 210 from the second electronic device 230. The unlocking command is an instruction from a user, or generated when the first electronic device is power off, which is not limited herein.

As stated above, the electronic control locking device is controlled electronically, when a first electronic device has communicates with a second electronic device, the electronic control locking device locks the first electronic device to the second electronic device to avoid errors when the first electronic device is accidentally detached from the second electronic device.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic system, comprising:
a first electronic device including a system operation center;
an electronic control locking device electrically connected to the first electronic device; and
a second electronic device including a storage device;
wherein when the first electronic device is combined with the second electronic device, the first electronic device sends a locking command to control the electronic control locking device to lock the first electronic device to the second electronic device, when the first electronic device sends an unlocking command, the electronic control locking device is unlocked to detach the first electronic device from the second electronic device.

2. The electronic system according to claim 1, wherein the first electronic device further includes a display screen electrically connected to the system operation center.

3. The electronic system according to claim 1, wherein when the first electronic device is combined with the second electronic device, the first electronic device is electrically connected to the second electronic device.

4. The electronic system according to claim 3, wherein the second electronic device further includes a keyboard module, when the second electronic device is combined with the first electronic device, the keyboard module and the storage device are electrically connected to the first electronic device.

5. The electronic system according to claim 1, wherein the electronic control locking device is an electromagnet or a motor.

6. The electronic system according to claim 1, wherein the first electronic device includes a first storage device, and the capacity of the storage device of the second electronic device is larger than the capacity of the first storage device.

7. The electronic system according to claim 1, wherein the first electronic device includes a first operating system and the second electronic device includes a second operating system.

8. The electronic system according to claim 1, wherein the locking command is generated when the first electronic device receives an instruction.

9. The electronic system according to claim 7, wherein when the first operating system of the first electronic device is switched to the second operating system of the second electronic device, the first electronic device generates the locking command.

10. The electronic system according to claim 1, wherein the unlocking command is generated when the first electronic system receives an instruction or the first electronic device is power off.
